(19) United States
(12) Patent Application Publication
(10) Pub. No.: US 2009/0024735 A1
(43) Pub. Date: Jan. 22, 2009

(54) METHOD AND SYSTEM OF CONTROLLING COMMUNICATIONS DELIVERY TO A USER

(76) Inventor: Michael G. Peddemors, Surrey (CA)

Correspondence Address: NEXUS LAW GROUP LLP, 1500 - 701 WEST GEORGIA STREET, VANCOUVER, BC, V7Y 1C6, CA

(21) Appl. No.: 11/781,063

(22) Filed: Jul. 20, 2007

(51) Int. Cl. G06F 15/173

(52) U.S. Cl. 709/224

(57) ABSTRACT

A method of controlling communications delivery to a user includes generating an internet protocol address space of internet protocol addresses for each of one or more communications networks operable to transmit marketing communications for delivery to the user; assigning an integrity value to an integrity rating associated with each communications network; assigning a user controllable selection to a set of receiving options associated with the communications networks; and filtering communications received from the communications networks in accordance with respective integrity values and the selection.

The method may be performed by a program including computer executable instructions embodied in a signal bearing medium.

A system includes a network integrity rating component; an options selection component; a database; and a filter for filtering communications.

### FIELD OF THE INVENTION

The invention relates to the field of communications and, in particular, to a method and system of controlling communications delivery to a user.

### BACKGROUND OF THE INVENTION

Some examples of communications include: bulk electronic mail (e-mail) communications or spam, marketing communications, unsolicited communications, previously solicited communications, automated facsimiles, and automated telephone calls. A communication for which a person has opted out of receiving may be referred to as an opted-out communication. A communication for which a person has in the past opted in to receiving may be referred to as an opted-in communication. A person may not want to receive a communication, even if that person has previously opted-in to receiving or otherwise requested the communication.

Various schemes have been used to prevent the delivery of unwanted communications to a user of a communications device. Communication devices include such devices as a computer, telephone, including a land-line-connected or wireless telephone, facsimile machine, radio, including a two-way radio, personal digital assistant or other similar communications device. By way of example, software filters have been developed in an attempt to prevent the delivery of spam type e-mail messages into e-mail inboxes of users.

United States patent application publication No. 2006/0130147 to Von-Maszewski discloses a method and system for identifying and stopping illegitimate communications attempts on the Internet from a sending IP (internet protocol) address where the sending IP address is controlled by an abusive message sender. However, the method and system of Von-Maszewski distributes to subscribers a risk assessment factor for each particular sending IP address having a risk assessment factor and requires that the subscribers determine whether to accept a connection request from each particular sending IP address.

An IP blacklist contains ranges of IP addresses belonging to ISPs that either allow spam to be transmitted from or through their IP addresses or have not taken action to prevent spammers from using their IP addresses to transmit spam. IP blacklist entries are often compiled by third parties unknown to a user and may be compiled anonymously. A typical user cannot easily verify the reliability or accuracy of the IP blacklist entries, and IP blacklists compiled from invited contributions are vulnerable to the nomination by spammers of legitimate entries in an attempt to corrupt the IP blacklist. Furthermore, an IP blacklist is of little help to a user using an e-mail delivery service that does not itself use the IP blacklist.

### SUMMARY OF THE INVENTION

The above shortcomings may be addressed by providing, in accordance with one aspect of the invention, a method of generating an internet protocol address space. The method involves: selecting a communication received from a communications source, the communication having been transmitted by a communications network for delivery to a user; obtaining an indication that the communication is a marketing communication; obtaining a set of internet protocol addresses associated with the communications network upon the indication; and storing the set of internet protocol addresses.

Selecting a communication received from a communications source, the communication having been transmitted by a communications network for delivery to a user, may involve selecting a multiple addressed communication. Selecting a communication received from a communications source, the communication having been transmitted by a communications network for delivery to a user, may involve receiving as user input a complaint identifying the communication. Selecting a communication received from a communications source, the communication having been transmitted by a communications network for delivery to a user, may involve randomly selecting the communication from among a plurality of received communications. Obtaining an indication that the communication is a marketing communication may involve receiving the indication as input. Obtaining an indication that the communication is a marketing communication may involve producing a content pattern associated with content of the communication, comparing the content pattern with a known content pattern associated with marketing communications and, if the content pattern matches the known content pattern, generating the indication. Obtaining an indication that the communication is a marketing communication may involve producing a transmission pattern associated with the communication, comparing the transmission pattern with a known transmission pattern associated with marketing communications and, if the transmission pattern matches the known transmission pattern, generating the indication. Producing a transmission pattern associated with the transmission of the communication may involve producing the transmission pattern on the basis of header information associated with the communication. The method may further involve selecting a plurality of communications received from the communications source, the communications having been transmitted by one or more communications networks for delivery to one or more users. Obtaining a set of internet protocol addresses associated with the communications network may involve obtaining at least one internet protocol address from header information associated with the communication. Storing the set of internet protocol addresses may involve storing the set of internet protocol addresses in a database. The method may further involve storing in the database an integrity value of an integrity rating associated with the communications network. The method may further involve adjusting the integrity value by selecting a second communication having been transmitted by the communications network for delivery to a user, and reducing the integrity value if the second communication is a marketing communication.

In accordance with another aspect of the invention, there is provided a method of controlling communications delivery to a user. The method involves: generating an internet protocol address space comprising internet protocol addresses associated with each of one or more communications networks operable to transmit marketing communications for delivery to the user; assigning an integrity value to an integrity rating associated with each of one or more communications networks operable to transmit marketing communications for delivery to the user; assigning a user controllable selection to a set of receiving options associated with the one or more communications networks; and filtering communications received from the one or more communications networks in accordance with one or more respective the integrity values and the selection.

Filtering communications received from the one or more communications networks in accordance with one or more respective the integrity values and the selection may involve preventing delivery to the user of a blocked subset of the marketing communications. Preventing delivery to the user of a marketing subset of the communications, the marketing subset consisting of marketing communications, may involve preventing delivery to the user of unsolicited marketing communications. Preventing delivery to the user of a marketing subset of the communications, the marketing subset consisting of marketing communications, may involve preventing delivery to the user of solicited marketing communications. Filtering communications received from the one or more communications networks in accordance with one or more respective the integrity values and the selection may involve making available to the user an unblocked subset of the communications. Making available to the user an unblocked subset of the communications may involve delivering the unblocked subset to an electronic mail inbox of the user. Making available to the user an unblocked subset of the communications may involve permitting the user to download the unblocked subset. Assigning a user controllable selection to a set of receiving options associated with the one or more communications networks may involve receiving input from the user indicating the user controllable selection. Assigning an integrity value to an integrity rating associated with each of one or more communications networks operable to transmit communications for delivery to the user may involve determining an extent to which respective the communications transmitted from the each communications network are marketing communications. Assigning an integrity value to an integrity rating associated with each of one or more communications networks operable to transmit communications for delivery to the user may involve assigning a low integrity value to the integrity rating in respect of a low integrity communications network permitting substantially unrestricted transmission of marketing communications. Assigning an integrity value to an integrity rating associated with each of one or more communications networks operable to transmit communications for delivery to the user may involve assigning a high integrity value to the integrity rating in respect of a high integrity communications network substantially restricting the transmission of marketing communications. The method may further involve maintaining a database containing the internet protocol address space.

In accordance with another aspect of the invention, there is provided a computer program product comprising computer executable instructions embodied in a signal bearing medium for performing a method of controlling communications delivery to a user. The method comprising: generating an internet protocol address space comprising internet protocol addresses associated with each of one or more communications networks operable to transmit marketing communications for delivery to the user; assigning an integrity value to an integrity rating associated with the each communications network; assigning a user controllable selection to a set of receiving options associated with the one or more communications networks; and filtering communications received from the one or more communications networks in accordance with one or more respective the integrity values and the selection.

The signal bearing medium may include at least one of a recordable computer readable medium and a signal transmission type medium. Assigning an integrity value to an integrity rating associated with the each communications networks may involve determining an extent to which respective the communications transmitted from the each communications network are marketing communications. Filtering communications received from the one or more communications networks in accordance with one or more respective the integrity values and the selection may involve preventing delivery to the user of a marketing subset of the communications that are marketing communications.

In accordance with another aspect of the invention, there is provided a system of controlling communications delivery to a user. The system includes: a network integrity rating component for assigning an integrity value to an integrity rating associated with each of one or more communications networks operable to transmit communications for delivery to the user; an options selection component for assigning a user controllable selection to a set of receiving options associated with the one or more communications networks; a database for storing the integrity value and a plurality of marketing communication internet protocol addresses in respective association with the each communications network; and a filter for filtering communications traceable to at least one of the plurality of internet protocol addresses in accordance with an associated the integrity value and the selection.

The system may be operable to determine an extent to which respective the communications transmitted from the each communications network are marketing communications. The system may be operable to prevent delivery to the user of a marketing subset of the communications, the marketing subset consisting of marketing communications.

In accordance with another aspect of the invention, there is provided a method of differentiating marketing communication from other types of communication. The method involves: selecting a communication received from a communications source, the communication having been transmitted by a communications network for delivery to a user; and obtaining an indication that the communication is a marketing communication.

Obtaining an indication that the communication is a marketing communication may involve receiving the indication as input. Obtaining an indication that the communication is a marketing communication comprises producing a content pattern associated with content of the communication, comparing the content pattern with a known content pattern associated with marketing communications and, if the content pattern matches the known content pattern, generating the indication. Obtaining an indication that the communication is a marketing communication may involve producing a transmission pattern associated with the communication, comparing the transmission pattern with a known transmission pattern associated with marketing communications and, if the transmission pattern matches the known transmission pattern, generating the indication. Producing a transmission pattern associated with the transmission of the communication may involve producing the transmission pattern on the basis of header information associated with the communication.

In accordance with another aspect of the invention, there is provided a method of controlling communications delivery to a user. The method involves: generating an internet protocol address space comprising internet protocol addresses associated with each of one or more communications networks operable to transmit marketing communications for delivery to the user; assigning an integrity value to an integrity rating associated with each of one or more communications networks operable to transmit marketing communications for delivery to the user; and assigning a user controllable selection to a set of receiving options associated with the one or more communications networks.

The method may further involve filtering communications received from the one or more communications networks in accordance with one or more respective the integrity values and the selection. Filtering communications received from the one or more communications networks in accordance with one or more respective the integrity values and the selection may involve preventing delivery to the user of a blocked subset of the marketing communications. Preventing delivery to the user of a marketing subset of the communications, the marketing subset consisting of marketing communications, may involve preventing delivery to the user of unsolicited marketing communications. Preventing delivery to the user of a marketing subset of the communications, the marketing subset consisting of marketing communications, may involve preventing delivery to the user of solicited marketing communications. Filtering communications received from the one or more communications networks in accordance with one or more respective the integrity values and the selection may involve making available to the user an unblocked subset of the communications. Assigning a user controllable selection to a set of receiving options associated with the one or more communications networks may involve receiving input from the user indicating the user controllable selection. Assigning an integrity value to an integrity rating associated with each of one or more communications networks operable to transmit communications for delivery to the user may involve determining an extent to which respective the communications transmitted from the each communications network are marketing communications. Assigning an integrity value to an integrity rating associated with each of one or more communications networks operable to transmit communications for delivery to the user may involve assigning a low integrity value to the integrity rating in respect of a low integrity communications network permitting substantially unrestricted transmission of marketing communications. Assigning an integrity value to an integrity rating associated with each of one or more communications networks operable to transmit communications for delivery to the user may involve assigning a high integrity value to the integrity rating in respect of a high integrity communications network substantially restricting the transmission of marketing communications. The method may further involve maintaining a database containing the internet protocol address space.

In accordance with another aspect of the invention, there is provided a method of controlling communications delivery to a user at the network level. The method involves: generating an internet protocol address space comprising internet protocol addresses associated with each of one or more communications networks operable to transmit marketing communications for delivery to the user; and assigning an integrity value to an integrity rating associated with each of one or more communications networks operable to transmit marketing communications for delivery to the user; and allowing a user to inform its communications provider that it does not want to receive communications originating from a communications network having a low integrity value associated therewith.

The method may further involve: assigning a user controllable selection to a set of receiving options associated with the one or more communications networks; and filtering communications received from the one or more communications networks in accordance with one or more respective the integrity values and the selection. Filtering communications received from the one or more communications networks in accordance with one or more respective the integrity values and the selection may involve preventing delivery to the user of a blocked subset of the marketing communications. Preventing delivery to the user of a marketing subset of the communications, the marketing subset consisting of marketing communications, may involve preventing delivery to the user of unsolicited marketing communications. Preventing delivery to the user of a marketing subset of the communications, the marketing subset consisting of marketing communications, may involve preventing delivery to the user of solicited marketing communications. Filtering communications received from the one or more communications networks in accordance with one or more respective the integrity values and the selection may involve making available to the user an unblocked subset of the communications. Assigning a user controllable selection to a set of receiving options associated with the one or more communications networks may involve receiving input from the user indicating the user controllable selection. Assigning an integrity value to an integrity rating associated with each of one or more communications networks operable to transmit communications for delivery to the user may involve determining an extent to which respective the communications transmitted from the each communications network are marketing communications. Assigning an integrity value to an integrity rating associated with each of one or more communications networks operable to transmit communications for delivery to the user may involve assigning a low integrity value to the integrity rating in respect of a low integrity communications network permitting substantially unrestricted transmission of marketing communications. Assigning an integrity value to an integrity rating associated with each of one or more communications networks operable to transmit communications for delivery to the user may involve assigning a high integrity value to the integrity rating in respect of a high integrity communications network substantially restricting the transmission of marketing communications. The method may further involve maintaining a database containing the internet protocol address space.

Other aspects and features of the invention will be appreciated by reference to the detailed description of embodiments in conjunction with the accompanying figures and to the claims that follow.

### BRIEF DESCRIPTION OF THE DRAWINGS

Embodiments of the invention will be described by reference to the drawings thereof in which:

FIG. 1 is a block diagram of a system in accordance with the first embodiment of the invention, showing the system interconnected with a number of communications networks;

FIG. 2 is a flow diagram of a method of controlling communications delivery to a user for which the system shown in FIG. 1 is operable to perform;

FIG. 3 is a flow diagram of a method of assigning an integrity value to an integrity rating of one or more communications networks by the system shown in FIG. 1;

FIG. 4 is a flow diagram of a method of assigning a selection to a set of receiving options of the communications networks by the system shown in FIG. 1;

FIG. 5 is a flow diagram of a method of filtering communications from the communications networks by the system shown in FIG. 1; and

FIG. 6 is a flow diagram of a method of generating an internet protocol address space by the system shown in FIG. 1.

### DETAILED DESCRIPTION OF EMBODIMENTS OF THE INVENTION

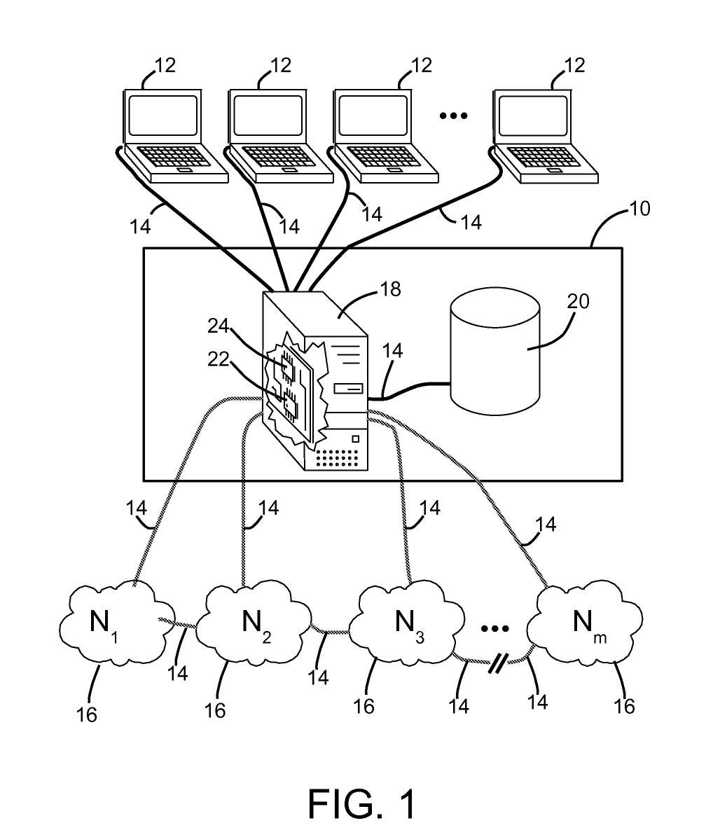

Referring to FIG. 1, a communications system for controlling communications delivery to a user in accordance with the first and preferred embodiment of the invention is shown generally at 10. Each communication may include e-mail messages, chat messages, audio recordings, video recordings, multi-media recordings, printable text, graphics, and any combination thereof, for example.

Briefly, the communications system 10 is operable to receive communications from a source within a communications network, deliver communications to users (not shown), identify networks that condone the transmission of marketing communications, store in a database internet protocol (IP) addresses associated with a communications network, filter communications received from the communications networks, and perform other operations described herein.

The communications system 10 includes any number of devices 12 that can be used by users (not shown) receiving communications through the communications system 10. While FIG. 1 shows laptop computers as illustrative of the devices 12, each device 12 may be any other type of computer, including any general purpose digital computer, and may be a modem, portable communications device, facsimile machine, telephone, including a land-line-connected or a wireless telephone such as a cellular or satellite telephone, radio, including a two-way radio, personal digital assistant or other equipment unit suitable for electronic communications.

The devices 12 are connected by connections 14 to any number of communications networks 16. In general, the devices 12, system 10 and communications networks 16 are typically each connected to the internet or other global communications networks. However, the devices 12 are preferably connected to the communications networks 16 through the system in respect of the operations, such as communications delivery, performed by the system 10.

In general, a communications network 16 may be any device or combination of connected devices operable to transmit communications. The communications networks 16, however, are typically operated by network service providers such as telecommunications common carriers and other network service providers who provide fee based communications services within and across their communications networks 16, including transmitting communications for delivery to a user of the communications system 10. Such carrier communications networks 16 and other communications networks 16 are generally interconnected and may form part or all of the Internet, the public switched telephone network and any combination thereof, for example.

The server 18 may itself be implemented as a device 12. The server 18 preferably forms part of the system 10 and may be operated by a user or by a business such as an e-mail service provider or other business using the server 18 to provide communications services, for example. The method and system of the invention may be performed by a plurality of devices 12 and/or servers 18 operating in coordination, parallel or redundantly, for example. Thus, the embodiment of FIG. 1 is merely illustrative of one embodiment of the invention.

The system 10 includes a database 20 shown in FIG. 1 in communication with the server 18. The database 20 functions primarily to store information, typically in the form of recordable and retrievable data for use within or by the system 10.

As shown in FIG. 1, the server 18 includes a processor 22 and a memory circuit 24. The processor 22 can be any processing circuitry operable to receive one or more inputs and perform computational operations on the received inputs to produce one or more outputs. The processor 22 is typically a digital processing circuit that includes one or more circuit units, such as a central processing unit (CPU), operating independently or in parallel, including possibly operating redundantly. The processor 22 may include circuitry for storing memory, such as digital data, and may comprise the memory circuit 24 or be in communication with the memory circuit 24, for example.

The database 20 and the memory circuit 24 are typically implemented as all or part of one or more integrated circuits (IC), including being implemented by a single monolithic integrated circuit (MIC). The database 20 and the memory circuit 24 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, and any combination thereof, for example. The memory circuit 24 may be operable to store memory as volatile memory, non-volatile memory, dynamic memory, and any combination thereof.

In some embodiments, the database 20 is implemented within the server 18. Additionally or alternatively, the database 20 may be implemented within any number of the devices 12 or within processors (not shown) of devices or equipment of the communications networks 16. However, for illustrative purposes the database 20 is shown in FIG. 1 as a stand alone unit in communication with the server 18.

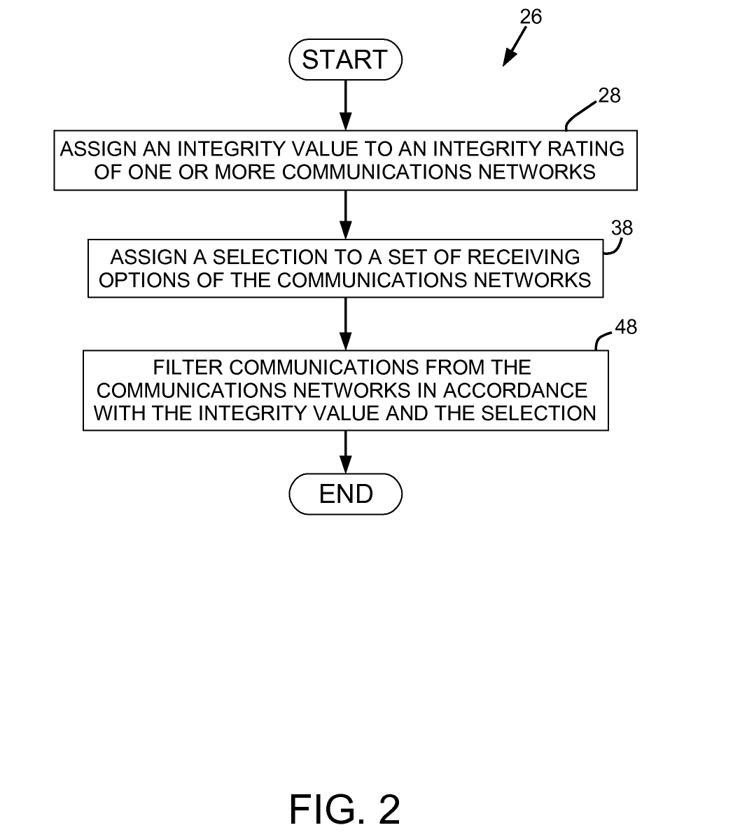

Referring to FIG. 2, the memory circuit 24 in accordance with the first embodiment of the invention contains blocks of code comprising computer executable instructions for directing the processor 22 to perform the steps of a method shown generally at 26.

When electrical power is being supplied to the processor 22 and the memory circuit 24, the processor 22 is directed to begin executing the instructions of block 28. Block 28 then directs the processor 22 to assign an integrity value to an integrity rating of one or more of the communications networks 16. In some embodiments, one integrity rating is associated with each communications network 16. Additionally or alternatively, a plurality of communications networks 16 may be grouped together and associated with a single integrity rating, to which an integrity value may be assigned.

By way of example, a number of communications networks 16 may be rated for their network service providers' historical activities regarding publication and compliance to anti-spam or other related policies; strictness in enforcing such policies; and promptness in responding to complaints regarding unwanted communications, for example. A network service provider's reputation among users, network service providers, industry experts or other parties may also serve as a basis for an integrity rating.

In some embodiments, the integrity rating for a given communications network or networks 16 is a grading or measure of the extent to which the network service providers operating the given communications networks 16 condone the transmission of unwanted communications. Condoning unwanted communications by a network service provider may involve permitting unwanted communications to be transmitted from or through the given communications networks 16, or have not taken action to prevent unwanted communications from being transmitted from or through the given communications networks 16.

Unwanted communications may include spam, marketing communications, unsolicited communications, previously solicited communications, bulk electronic mail (e-mail) communications, automated facsimile communications, automated telephone calls, communications for which a person has opted out of receiving (i.e. opted-out communications), communications for which a person has in the past opted in to receive (i.e. opted-in communications) and other communications may not be wanted or may no longer be wanted by the person receiving such communications.

In the first embodiment, the integrity value is quantified, in whole or in part, by determining the extent to which communications transmitted from a given communications network 16 contain marketing material. For example, a given communication may predominantly contain marketing material, entirely contain marketing material, contain minimal amounts of marketing material or not contain any marketing material at all. Varying proportions of the communications transmitted from the given communications network 16 can contain marketing material. In some embodiments, the integrity rating is implemented as a flag to indicate whether or not a preponderance of such communications contain, or predominantly contain for example, marketing material. The flag can serve to identify a communications network 16 as a marketing network.

Marketing material can be identified in a given communication through an analysis of the content of the given communication. By way of example, similarities between the content and known signatures of marketing engines can be detected. The predominance of marketing material within the given communication can be quantified as a proportion of the content having the signature of a marketing engine or other similarity to known marketing material patterns, for example. The extent of transmitted communications identified as containing marketing material can be determined as a proportion of the overall communications traffic transmitted from the given communications network 16. For example, statistics related to frequency and volume of such identified communications can quantify the proportion.

Other information can also be employed in determining the extent to which communications transmitted from the given communications network 16 contain marketing material and, in particular, which communications merit further analysis in determining such extent. Such other information may include whether a temporary domain name has been used in the transmission of a given communication, whether the identity of the source of the given communication has been obfuscated, or any combination thereof, for example. A historical reputation may be assigned to a given communications network 16 and may be used in conjunction with or in place of determining the extent to which communications transmitted from the given communications network 16 contain marketing material. The communications containing marketing material may be considered a marketing subset of all the communications received by the system 10.

The system 10 is operable to assign to a given integrity rating any number of integrity values, including integrity values designated by descriptors such as “not a marketing network”, “excellent”, “very good”, “good”, “fair”, “adequate”, “moderate”, “poor”, “bad”, “low”, “very poor”, “very bad”, “very low”, “marketing network” and others, including “yes” and “no” or “true” and “false”, for example.

Additionally or alternatively, integrity values may be expressed, assigned and/or stored as numerical values. By way of example, the average percentage of all communications transmitted by a given communications network 16 that were flagged during a test period as being an unwanted communication or a specified subset thereof could serve as the integrity value assigned in association with the given communications network 16. The statistical probability of the given communications network transmitting a communication containing marketing material could also serve as a numerical integrity value, for example.

The system 10 is operable to define numerical ranges associated with integrity value descriptors and determine the numerical range within which lies a given numerical integrity value, thereby associating numerical integrity values with descriptive categories or descriptors. For example, the descriptors “good”, “poor” and “very poor” might be associated with three sequential ranges of probabilities between zero (0) and one (1).

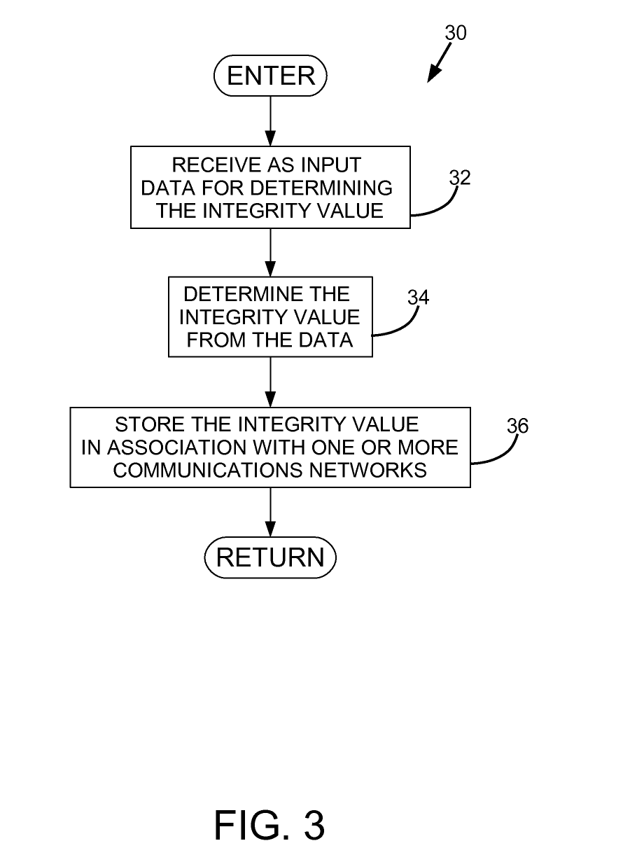

Referring to FIG. 3, an exemplary method for directing the processor 22 to perform steps of block 28 (FIG. 2) in respect of a given communications network or networks 16 is shown generally at 30. Method 30 begins execution at block 32, which directs the processor 22 to receive, as input to the system 10, data for determining the integrity value. The data may be received as a single contiguous set of data or received in data segments, including receiving different segments at different times, for example. The data may be representative of any suitable information, including information described above with respect to block 28 (FIG. 2). In some embodiments, the received data is a subset associated with the given communications networks 16 of a larger set of data associated with a number of communications networks 16.

Block 34 then directs the processor 22 to determine the integrity value on the basis of the data received by block 32. The effect of executing block 34 may be to obtain a low integrity value in the case of a low integrity communications network 16, such as a communications network 16 for which the transmission of unwanted communications is substantially unrestricted or otherwise poorly restricted, and to obtain a high integrity value in the case of a high integrity communications network 16 for which the transmission of unwanted communications are substantially restricted or otherwise effectively restricted, for example. In some embodiments, a low integrity value is assigned to a low integrity communications network 16 permitting substantially unrestricted transmission of communications containing marketing material and a high integrity value is assigned to a high integrity communications network 16 effectively restricting the transmission of communications containing marketing material.

Block 36 then directs the processor 22 to store the integrity value determined by block 34 in association with the given communications network or networks 16. The integrity value can be stored in the memory circuit 24. Additionally or alternatively, the integrity value can be stored in the database 20. Storing an integrity value in association with its associated communications network or networks 16 generally involves storing data representative of the identity of the associated communications network. Such data may include ranges of IP addresses belonging to or in use by the associated communications network 16.

After block 36 has been executed, the processor 22 is then directed to return to block 28 of FIG. 2. Depending on the number of communications networks 16 under consideration, block 28 may be re-executed a number of times until integrity ratings associated with all communications networks 16 have been assigned integrity values.

As shown in FIG. 2, after block 28 has been executed in respect of all communications networks 16 under consideration, block 38 then directs the processor 22 to assign a selection to a set of receiving options of at least one of the communications networks 16. The system 10 is operable to assign a different selections for each user of the system 10 and to permit each user's selection or selections to be controlled, including being changed from time to time or reset to a default selection value, by the user. In some embodiments, the system 10 is operable to permit the user to make a different selection in respect of different communications networks 16, to make a single selection in respect of a group of communications networks 16, to make a single selection in respect of all communications networks 16 having an associated integrity rating, and any combination thereof.

To permit the user to make an informed decision regarding their selection or selections, the system 10 in some embodiments is operable to present to the user or otherwise make available to the user the integrity values assigned by block 28. In some embodiments, for user convenience, identifiers of the communications networks 16 are displayed to the user in groups categorized under headings such as “good”, “acceptable”, “bad” or other indicators representative of the integrity values associated with the communications networks 16. Each communications network 16 may be identified by a list of IP addresses belonging to the communications network 16, by the name of the network service provider for the communications network 16, or by other designations.

In the first embodiment, the receiving options are made available to the user for their consideration. The receiving options may be presented under category headings such as “strong protection”, “medium protection” and “no protection”, or may be presented as captions such as “Block communications from networks having a low integrity rating”, “Block communications from networks having a very poor integrity rating only” and “Do not block communications at the network level”, for example. The number of user controllable selections in the set of receiving options is not restricted to three. For example, the user may be permitted to select between the options of no protection and full protection or between any number of suitably presented options, for example. In the first embodiment, the user is permitted to change the selection from the default selection at any time and to repeatedly change their selection as the user may wish. However, it is possible for the system 10 to require special processing by someone other than the user, such as an administrator or service provider representative, to effect a change in selection for a user.

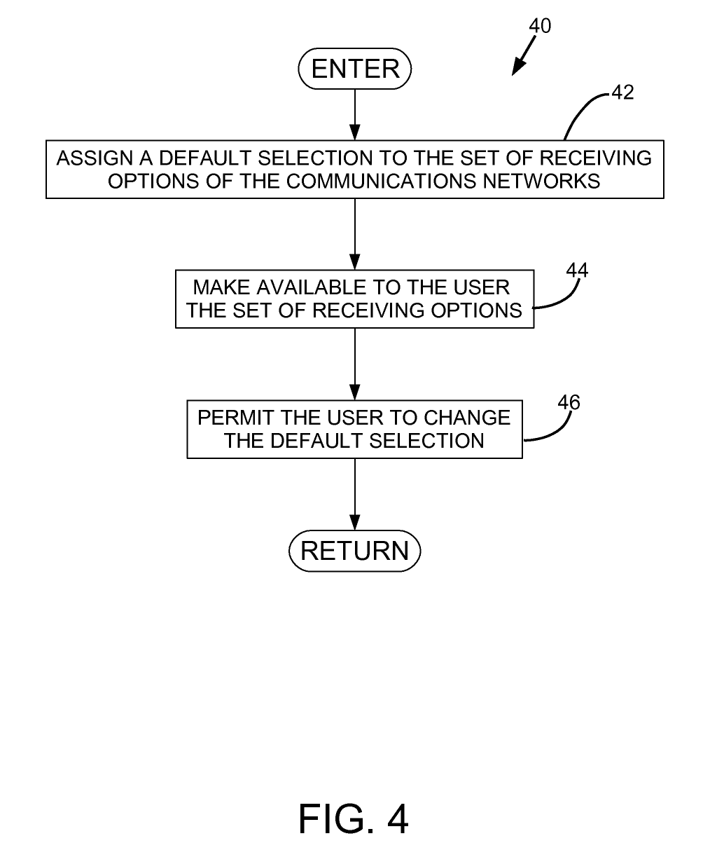

Referring to FIG. 4, an exemplary method for directing the processor 22 to perform steps of block 38 (FIG. 2) in respect of a given communications network or networks 16 is shown generally at 40. Method 40 begins execution at block 42, which directs the processor 22 to assign a default selection to the set of receiving options. Block 42 may be executed once for each new user when services for the new user are initially provided, for example. In some embodiments, the user may be requested to make a selection prior to initiating services for that user, and the initial selection of the user becomes the default selection. Additionally or alternatively, the default selection may be assigned by the system without receiving input from a user.

Block 44 then directs the processor 20 to make available to the user the set of receiving options. Typically, the user is permitted to access the receiving options settings in a computer program sub-menu, such as a receiving options sub-menu of an options menu, for example. In some embodiments, the set of receiving options are made available to the user by other means such as by a printed information sheet or by telephony, including possibly by messaging, for example. Additionally or alternatively, one set of receiving options may be made available to the user in respect of each communications network 16, in respect of each group of communications networks 16, in respect of all communications networks 16 having associated therewith an integrity rating, or any combination thereof, for example.

Block 46 then directs the processor 20 to permit the user to change the default selection for a given set of receiving options. The default selection can be changed to the same or other selection among the set of receiving options made available to the user by executing block 44. Permitting the user to change a selection may involve receiving, as input, data representing a selection and storing the received data for later retrieval. The selection of a user may be stored in the memory circuit 24 or the database 20, and may be stored in association with other data such as data identifying the user. When block 46 has been executed, the processor 20 is directed to return to the method 26 (FIG. 2). In some embodiments, the method 40 of FIG. 4 is re-executed for a given user in respect of a number of different sets of receiving options.

Referring back to FIG. 2, after the users' selections have been assigned to the receiving options, block 48 directs the processor 20 to filter communications received from the one or more communications networks 16 in accordance with the integrity value and the selection. For a given user, where different integrity values and/or different selections have been assigned to different communications networks 16, or groups of communications networks 16, block 48 is operable to filter communications received from separate communications networks 16 in accordance with respectively associated integrity values and selections.

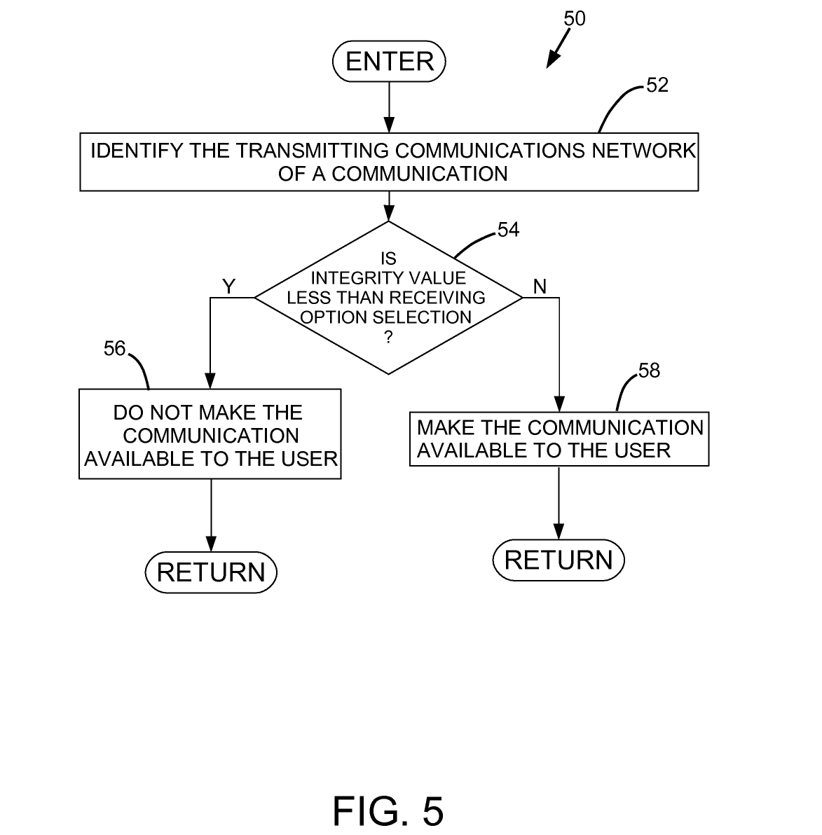

Referring to FIG. 5, an exemplary method for directing the processor 22 to perform steps of block 48 (FIG. 2) in respect of a given communication is shown generally at 50. Method 50 begins execution at block 52, which directs the processor 22 to determine the identity of the transmitting communications network 16 from which the given communication has been transmitted. In this manner, the given communication can be associated with the integrity value and the user's receiving option selection previously associated with the transmitting communications network 16.

Executing block 52 typically involves obtaining source network identification information from the content of the communication, such as by analyzing the transmission header information associated with the communication to obtain an IP address from which the communication was transmitted, and comparing the IP address with IP addresses stored in the database 20 in association with the communications networks 16 to identify the transmitting communications network 16 from which the communication was received. In some embodiments, the system is operable to identify the transmitting communications network 16 by determining at least one communications network 16 from which the communication was received, the closest communications network 16 from which the communication was directly or most recently received, the most distant communications network 16 from which the communication was transmitted before being received by one or more other communications networks 16, the source communications network 16 from which the communication originated, or any combination thereof.

Block 54 then directs the processor 20 to determine whether the integrity value is a lower value than that associated with the user's receiving option selection for the transmitting communications network 16. Making such determination typically involves having assigned a comparative ordering to the integrity values and the receiving options. In this manner, the system 10 is operable to filter out communications received from communications networks 16 for which the user has selected for blocking.

By way of example in the case where the receiving options are “strong protection”, “medium protection” and “no protection” and the integrity values are “good”, “poor” and “very poor”, the system 10 is operable to determine that the integrity value of “good” is equal to or higher than that associated with all three receiving option selections; the integrity value of “poor” is less than the selection “istrong protection”, but equal to or higher than the other selections; and that the integrity value of “very poor” is equal or higher than the selection “no protection” and less than the other selections, for example.

In some embodiments where the receiving options are “protect” and “no protection” and the integrity values are “marketing network” and “not a marketing network”, the system 10 is operable to determine that the integrity value of “not a marketing network” is equal to or higher than that associated with both receiving option selections; and that the integrity value of “marketing network” is equal or higher than the selection “no protection” and less than the selection “protect”, for example.

In the case of numerical integrity values, such numerical integrity values may be associated with descriptive categories, including descriptors such as “good”, “poor” and “very poor”. Additionally or alternatively, the receiving option selections may be assigned numerical values or numerical ranges for comparison with numerical integrity values, for example.

Executing block 54 typically involves retrieving data, including the integrity value and the user's receiving option selection, from the database 20 associated with the given communications network 16 and the given user, and comparing their relative values as described herein.

If by executing block 54, the system determines that the integrity value is less than that of the receiving option selection, then the processor 20 is directed to execute block 56.

Block 56 directs the processor 20 to filter out the given communication such that it is not made available to the user in the same fashion as unfiltered communications, or not made available to the user at all. In the first embodiment, the system prevents the delivery of the communication to the user. In the case of an automated facsimile, the system 10 may prevent the delivery of the communication to the user's facsimile machine or other device 12 (FIG. 1) operable to receive a facsimile, for example. In the case of an automated telephone call, the system 10 is in some embodiments operable to intercept the telephone call and prevent the receiving telephone from ringing or accepting the call. In the case of an e-mail communication, preventing delivery may involve delivering the communication to a special e-mail folder, such as an unwanted communications folder, junk folder or deleted e-mails folder, rather than delivering the e-mail communication to the user's e-mail inbox. Alternatively, preventing delivery of an e-mail communication may involve deleting the communication from the system 10 without in any way making the e-mail communication available to the user at the user's device 12 (FIG. 1).

While the system 10 is operable to prevent the delivery of unsolicited communications such as spam, unsolicited marketing communications or communications which are both spam and unsolicited marketing communications, the system is also operable to filter solicited communications. In this manner, it is possible for a user to register for a membership or associate themselves with an on-line service and in the process, knowingly or unknowingly, opt-in to receiving communications which may be considered solicited (due to the user having opted in) marketing communications. By appropriate selection of a receiving option, the system 10 is operable to prevent the delivery of unwanted, even though solicited, marketing communications, for example.

After executing block 56, the processor 20 is directed to return to the method 26 of FIG. 2.

If by executing block 54, the system determines that the integrity value is not less than that of the receiving option selection, then the processor 20 is directed to execute block 58.

Block 58 directs the processor 20 to make available to the user the given communication. In some embodiments, making a communication available to a user involves delivering the communication to an e-mail inbox of the user. Additionally or alternatively, the communication may be made available for downloading by the user, including downloading from a Web site of the Internet, for example. In the case of an automated facsimile or automated telephone call, the delivery of the communication to the user's facsimile machine or telephone or other device 12 (FIG. 1) may be permitted to proceed unimpeded, for example.

After executing block 58, the processor 20 is directed to return to the method 26 of FIG. 2.

In the first embodiment, the system 10 is operable to execute the method 50 shown in FIG. 5 for each communication received from a communications network 16. The method 50 may be re-iterated for each new communication received by the system 10 from a communications network 16, and the order of performing iterations thereof may follow the timing of the receipt of communications by the system 10, for example. However, other variations within the scope contemplated by the invention include performing a number of iterations of step 52 followed by performing iterations of steps 54 to 58 ordered according to the identity of the communications networks 16, the user, defined priorities, and any combination thereof. In some embodiments, the system 10 is operable to execute in parallel the methods and steps described herein.

The communications received from the communications networks 16 which are determined by block 54 to have been received from a communications network 16 for which its associated integrity value is less than that of its associated received option selection may be considered to form a subset of communications for which delivery can be prevented, including possibly preventing by executing block 56.

Referring back to FIG. 2, after block 48 is executed, the processor 20 is directed to end the method 26. In some embodiments, however, the system 10 is generally continually monitoring for new communications received from the communications networks 16, and performing filtering operations in accordance with the invention in an iterative fashion.

Thus, there is provided a method of controlling communications delivery to a user, the method comprising assigning an integrity value to an integrity rating associated with each of one or more communications networks operable to transmit communications for delivery to the user; assigning a user controllable selection to a set of receiving options associated with said one or more communications networks; and filtering communications received from said one or more communications networks in accordance with one or more respective said integrity values and said selection.

Internet Protocol Address Space

Controlling communications delivery to a user is preferably facilitated by use of an internet protocol address space.

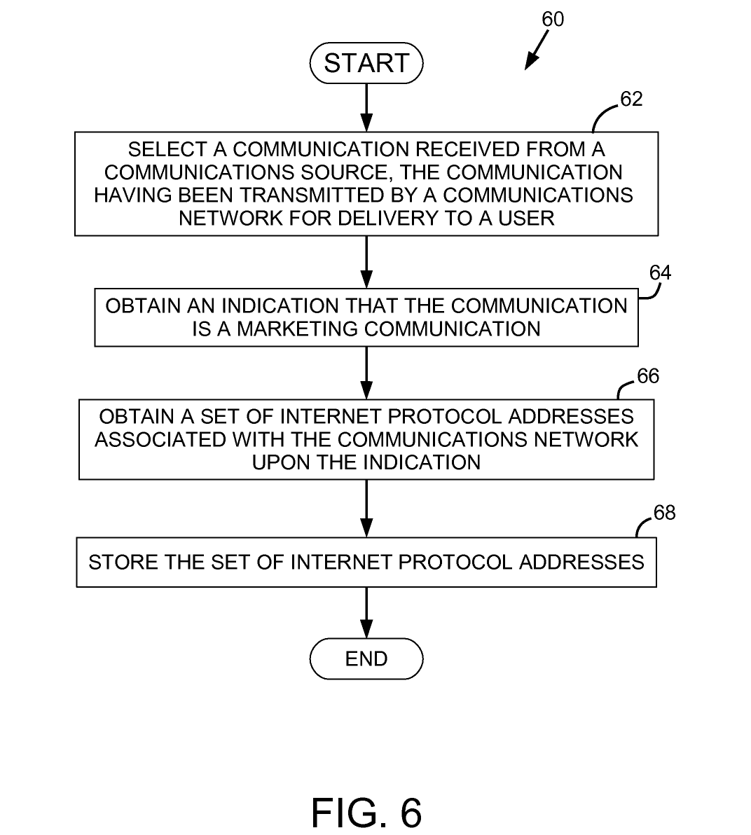

Referring to FIG. 6, the system 10 in some embodiments is operable to generate an internet protocol address space by a method shown generally at 60.

Block 62 directs the processor 22 to select a communication received from a communications source, the communication having been transmitted by a communications network 16 for delivery to a user. Typically, a communications source can be any device within a given communications network 16 that is operable to initiate the transmission of a communication. A communications source may include a device 12 or similar, for example.

The communication may be selected using a variety of criteria. For example, a communication may be selected from among multiple addressed communications being sent to multiple recipients. Additionally or alternatively, the system 10 is operable to select a communication for which a complaint, such as a complaint received from a user, has been received. In some embodiments, or in some instances, a communication may be randomly selected.

Block 64 then directs the processor 22 to obtain an indication as to whether the selected communication is a marketing communication. The system 10 is preferably operable to receive the indication as an input to the system 10. Additionally or alternatively, the system 10 is in some embodiments operable to produce a content pattern associated with the content of the communication. The system 10 can then compare the content pattern with a known content pattern associated with marketing communications and, if there is a match, generate the indication. The known content pattern may be produced on the basis of communications already known to be marketing communications. The content considered may include any text, images, etc. of the body of the communication, any header information associated with the communication and any combination thereof, for example.

Additionally or alternatively, the system 10 is in some embodiments operable to produce a transmission pattern associated with the communication. The system 10 can then compare the transmission pattern with a known transmission pattern associated with marketing communications and, if there is a match, generate the indication. The known transmission pattern may be produced on the basis of communications already known to be marketing communications. The transmission pattern may be generated on the basis of any information that can be obtained which is related to the transmission of the selected communication, including header information for example.

Block 66 directs the processor 22 to obtain a set of internet protocol addresses associated with the communications network 16 that transmitted the communication selected by executing block 62. Preferably, block 66 directs the processor 22 to obtain the set of internet protocol addresses upon the indication that the communications network 16 is a marketing communication. In some embodiments, the system 10 is operable not to obtain the set of internet protocol addresses unless the indication obtained by block 64 indicates that the communications network 16 is a marketing communication.

The system 10 is operable to obtain the set of internet protocol addresses as an input to the system. Additionally or alternatively, the system 10 is operable to obtain the set by other techniques and methods. For example, the system 10 is operable in some embodiments to monitor communications and analyze their contents, including header information thereof, to determine internet protocol addresses associated with a given communications network 16. Typically, at least one internet protocol address can be obtained from the header information of the marketing communication determined by block 64.

Block 68 directs the processor 22 to store the set of internet protocol addresses. Although not necessary in all embodiments of the invention, the set is preferably stored in the database 18. The set of internet protocol addresses for a given communications network 16 can be stored in the database 18 in association with other information about the given communications network 16, such as an integrity value of an integrity rating associated with the given communications network 16.

The system 10 in some embodiments is also operable to adjust the integrity value of an integrity rating already associated with the given communications network 16 on the basis of the results of the method steps shown in FIG. 6. The method 60 may further include the step (not shown) of selecting a second communication having been transmitted by the same communications network 16 for delivery to a user, not necessarily the same user, and reducing the associated integrity value if the second communication is a marketing communication. This additional step may involve re-iterating one or more steps shown in FIG. 6. In this manner, integrity ratings for communications networks 16 can be maintained in the database 18 and updated with each new communication that happens to be a marketing communication.

Blocks 62, 64, 66 and 68 may be executed once for each execution of method 60, as shown in FIG. 6, or multiple times in respect of the same or different communications. In some embodiments, the system 10 is operable to select a plurality of communications, then obtain respective indications for the plurality of communications, then obtain respective sets of internet protocol addresses, and then store the respective sets. Other suitable orders of executing the method 60 steps, including executing method 60 steps in parallel, are also within the scope contemplated by the present invention.

Thus, there is provided a method of generating an internet protocol address space, the method comprising: selecting a communication received from a communications source, said communication having been transmitted by a communications network for delivery to a user; obtaining an indication that said communication is a marketing communication; obtaining a set of internet protocol addresses associated with said communications network upon said indication; and storing said set of internet protocol addresses.

While embodiments of the invention have been described and illustrated, such embodiments should be considered illustrative of the invention only. The invention may include variants not described or illustrated herein in detail. For example, the orders in which steps of the method in accordance with embodiments of the invention may in some embodiments be varied, including possibly assigning a user controllable selection before assigning an integrity value, for example. Thus, the embodiments described and illustrated herein should not be considered to limit the invention as construed in accordance with the accompanying claims.

1. A method of generating an internet protocol address space, the method comprising:
(a) selecting a communication received from a communications source, said communication having been transmitted by a communications network for delivery to a user;
(b) obtaining an indication that said communication is a marketing communication;
(c) obtaining a set of internet protocol addresses associated with said communications network upon said indication; and
(d) storing said set of internet protocol addresses.

2. The method of claim 1 wherein selecting a communication received from a communications source, said communication having been transmitted by a communications network for delivery to a user, comprises selecting a multiple addressed communication.

3. The method of claim 1 wherein selecting a communication received from a communications source, said communication having been transmitted by a communications network for delivery to a user, comprises receiving as user input a complaint identifying said communication.

4. The method of claim 1 wherein selecting a communication received from a communications source, said communication having been transmitted by a communications network for delivery to a user, comprises randomly selecting said communication from among a plurality of received communications.

5. The method of claim 1 wherein obtaining an indication that said communication is a marketing communication comprises receiving said indication as input.

6. The method of claim 1 wherein obtaining an indication that said communication is a marketing communication comprises producing a content pattern associated with content of said communication, comparing said content pattern with a known content pattern associated with marketing communications and, if said content pattern matches said known content pattern, generating said indication.

7. The method of claim 1 wherein obtaining an indication that said communication is a marketing communication comprises producing a transmission pattern associated with said communication, comparing said transmission pattern with a known transmission pattern associated with marketing communications and, if said transmission pattern matches said known transmission pattern, generating said indication.

8. The method of claim 7 wherein producing a transmission pattern associated with the transmission of said communication comprises producing said transmission pattern on the basis of header information associated with said communication.

9. The method of claim 1 further comprising selecting a plurality of communications received from said communications source, said communications having been transmitted by one or more communications networks for delivery to one or more users.

10. The method of claim 1 wherein obtaining a set of internet protocol addresses associated with said communications network comprises obtaining at least one internet protocol address from header information associated with said communication.

11. The method of claim 1 wherein storing said set of internet protocol addresses comprises storing said set of internet protocol addresses in a database.

12. The method of claim 11 further comprising storing in said database an integrity value of an integrity rating associated with said communications network.

13. The method of claim 12 further comprising adjusting said integrity value by selecting a second communication having been transmitted by said communications network for delivery to a user, and reducing said integrity value if said second communication is a marketing communication.

14. A method of controlling communications delivery to a user, the method comprising:
(a) generating an internet protocol address space comprising internet protocol addresses associated with each of one or more communications networks operable to transmit marketing communications for delivery to the user;
(b) assigning an integrity value to an integrity rating associated with each of one or more communications networks operable to transmit marketing communications for delivery to the user;
(c) assigning a user controllable selection to a set of receiving options associated with said one or more communications networks; and
(d) filtering communications received from said one or more communications networks in accordance with one or more respective said integrity values and said selection.

15. The method of claim 14 wherein filtering communications received from said one or more communications networks in accordance with one or more respective said integrity values and said selection comprises preventing delivery to the user of a blocked subset of said marketing communications.

16. The method of claim 15 wherein preventing delivery to the user of a marketing subset of said communications, said marketing subset consisting of marketing communications, comprises preventing delivery to the user of unsolicited marketing communications.

17. The method of claim 15 wherein preventing delivery to the user of a marketing subset of said communications, said marketing subset consisting of marketing communications, comprises preventing delivery to the user of solicited marketing communications.

18. The method of claim 14 wherein filtering communications received from said one or more communications networks in accordance with one or more respective said integrity values and said selection comprises making available to the user an unblocked subset of said communications.

19. The method of claim 14 wherein assigning a user controllable selection to a set of receiving options associated with said one or more communications networks comprises receiving input from the user indicating said user controllable selection.

20. The method of claim 14 wherein assigning an integrity value to an integrity rating associated with each of one or more communications networks operable to transmit communications for delivery to the user comprises determining an extent to which respective said communications transmitted from said each communications network are marketing communications.

21. The method of claim 20 wherein assigning an integrity value to an integrity rating associated with each of one or more communications networks operable to transmit communications for delivery to the user comprises assigning a low integrity value to said integrity rating in respect of a low integrity communications network permitting substantially unrestricted transmission of marketing communications.

22. The method of claim 20 wherein assigning an integrity value to an integrity rating associated with each of one or more communications networks operable to transmit communications for delivery to the user comprises assigning a high integrity value to said integrity rating in respect of a high integrity communications network substantially restricting the transmission of marketing communications.

23. The method of claim 14 further comprising maintaining a database containing said internet protocol address space.

24. A computer program product comprising computer executable instructions embodied in a signal bearing medium for performing a method of controlling communications delivery to a user, the method comprising:
(a) generating an internet protocol address space comprising internet protocol addresses associated with each of one or more communications networks operable to transmit marketing communications for delivery to the user;
(b) assigning an integrity value to an integrity rating associated with said each communications network;
(c) assigning a user controllable selection to a set of receiving options associated with said one or more communications networks; and
(d) filtering communications received from said one or more communications networks in accordance with one or more respective said integrity values and said selection.

25. The computer program product of claim 24 wherein said signal bearing medium comprises at least one of a recordable computer readable medium and a signal transmission type medium.

26. The computer program product of claim 24 wherein assigning an integrity value to an integrity rating associated with said each communications networks comprises determining an extent to which respective said communications transmitted from said each communications network are marketing communications.

27. The computer program product of claim 24 wherein filtering communications received from said one or more communications networks in accordance with one or more respective said integrity values and said selection comprises preventing delivery to the user of a marketing subset of said communications that are marketing communications.

28. A system of controlling communications delivery to a user, the system comprising:
(a) a network integrity rating component for assigning an integrity value to an integrity rating associated with each of one or more communications networks operable to transmit communications for delivery to the user;
(b) an options selection component for assigning a user controllable selection to a set of receiving options associated with said one or more communications networks;
(c) a database for storing said integrity value and a plurality of marketing communication internet protocol addresses in respective association with said each communications network; and
(d) a filter for filtering communications traceable to at least one of said plurality of internet protocol addresses in accordance with an associated said integrity value and said selection.

29. The system of claim 28 wherein the system is operable to determine an extent to which respective said communications transmitted from said each communications network are marketing communications.

30. The system of claim 28 wherein the system is operable to prevent delivery to the user of a marketing subset of said communications, said marketing subset consisting of marketing communications.

31. A method of differentiating marketing communication from other types of communication, the method comprising:
(a) selecting a communication received from a communications source, said communication having been transmitted by a communications network for delivery to a user; and
(b) obtaining an indication that said communication is a marketing communication.

32. The method of claim 31 wherein obtaining an indication that said communication is a marketing communication comprises receiving said indication as input.

33. The method of claim 31 wherein obtaining an indication that said communication is a marketing communication comprises producing a content pattern associated with content of said communication, comparing said content pattern with a known content pattern associated with marketing communications and, if said content pattern matches said known content pattern, generating said indication.

34. The method of claim 31 wherein obtaining an indication that said communication is a marketing communication comprises producing a transmission pattern associated with said communication, comparing said transmission pattern with a known transmission pattern associated with marketing communications and, if said transmission pattern matches said known transmission pattern, generating said indication.

35. The method of claim 34 wherein producing a transmission pattern associated with the transmission of said communication comprises producing said transmission pattern on the basis of header information associated with said communication.

36. A method of controlling communications delivery to a user, the method comprising:
(a) generating an internet protocol address space comprising internet protocol addresses associated with each of one or more communications networks operable to transmit marketing communications for delivery to the user;
(b) assigning an integrity value to an integrity rating associated with each of one or more communications networks operable to transmit marketing communications for delivery to the user; and
(c) assigning a user controllable selection to a set of receiving options associated with said one or more communications networks.

37. The method of claim 36 further comprising filtering communications received from said one or more communications networks in accordance with one or more respective said integrity values and said selection.

38. The method of claim 37 wherein filtering communications received from said one or more communications networks in accordance with one or more respective said integrity values and said selection comprises preventing delivery to the user of a blocked subset of said marketing communications.

39. The method of claim 38 wherein preventing delivery to the user of a marketing subset of said communications, said marketing subset consisting of marketing communications, comprises preventing delivery to the user of unsolicited marketing communications.

40. The method of claim 38 wherein preventing delivery to the user of a marketing subset of said communications, said marketing subset consisting of marketing communications, comprises preventing delivery to the user of solicited marketing communications.

41. The method of claim 37 wherein filtering communications received from said one or more communications networks in accordance with one or more respective said integrity values and said selection comprises making available to the user an unblocked subset of said communications.

42. The method of claim 36 wherein assigning a user controllable selection to a set of receiving options associated with said one or more communications networks comprises receiving input from the user indicating said user controllable selection.

43. The method of claim 36 wherein assigning an integrity value to an integrity rating associated with each of one or more communications networks operable to transmit communications for delivery to the user comprises determining an extent to which respective said communications transmitted from said each communications network are marketing communications.

44. The method of claim 43 wherein assigning an integrity value to an integrity rating associated with each of one or more communications networks operable to transmit communications for delivery to the user comprises assigning a low integrity value to said integrity rating in respect of a low integrity communications network permitting substantially unrestricted transmission of marketing communications.

45. The method of claim 43 wherein assigning an integrity value to an integrity rating associated with each of one or more communications networks operable to transmit communications for delivery to the user comprises assigning a high integrity value to said integrity rating in respect of a high integrity communications network substantially restricting the transmission of marketing communications.

46. The method of claim 36 further comprising maintaining a database containing said internet protocol address space.

47. A method of controlling communications delivery to a user at the network level, the method comprising:
(a) generating an internet protocol address space comprising internet protocol addresses associated with each of one or more communications networks operable to transmit marketing communications for delivery to the user; and
(b) assigning an integrity value to an integrity rating associated with each of one or more communications networks operable to transmit marketing communications for delivery to the user; and
(c) allowing a user to inform its communications provider that it does not want to receive communications originating from a communications network having a low integrity value associated therewith.

48. The method of claim 47 further comprising:
(a) assigning a user controllable selection to a set of receiving options associated with said one or more communications networks; and
(b) filtering communications received from said one or more communications networks in accordance with one or more respective said integrity values and said selection.

49. The method of claim 48 wherein filtering communications received from said one or more communications networks in accordance with one or more respective said integrity values and said selection comprises preventing delivery to the user of a blocked subset of said marketing communications.

50. The method of claim 49 wherein preventing delivery to the user of a marketing subset of said communications, said marketing subset consisting of marketing communications, comprises preventing delivery to the user of unsolicited marketing communications.

51. The method of claim 49 wherein preventing delivery to the user of a marketing subset of said communications, said marketing subset consisting of marketing communications, comprises preventing delivery to the user of solicited marketing communications.

52. The method of claim 48 wherein filtering communications received from said one or more communications networks in accordance with one or more respective said integrity values and said selection comprises making available to the user an unblocked subset of said communications.

52. (canceled)

53. The method of claim 48 wherein assigning an integrity value to an integrity rating associated with each of one or more communications networks operable to transmit communications for delivery to the user comprises determining an extent to which respective said communications transmitted from said each communications network are marketing communications.

54. The method of claim 53 wherein assigning an integrity value to an integrity rating associated with each of one or more communications networks operable to transmit communications for delivery to the user comprises assigning a low integrity value to said integrity rating in respect of a low integrity communications network permitting substantially unrestricted transmission of marketing communications.

55. The method of claim 53 wherein assigning an integrity value to an integrity rating associated with each of one or more communications networks operable to transmit communications for delivery to the user comprises assigning a high integrity value to said integrity rating in respect of a high integrity communications network substantially restricting the transmission of marketing communications.

56. The method of claim 47 further comprising maintaining a database containing said internet protocol address space.

57. The method of claim 48 wherein assigning a user controllable selection to a set of receiving options associated with said one or more communications networks comprises receiving input from the user indicating said user controllable selection.
